(19) United States
(12) Patent Application Publication
(10) Pub. No.: US 2024/0082934 A1
(43) Pub. Date: Mar. 14, 2024

(54) TOOL SHANK HOLDERS AND METHODS OF ATTACHING TOOLS USING TOOL SHANK HOLDERS TO POWER TOOLS

(71) Applicant: Toyota Motor Engineering & Manufacturing North America, Inc., Plano, TX (US)

(72) Inventors: Charles L. Cain, Verona, KY (US); Blair C. Perkins, Georgetown, KY (US)

(73) Assignees: Toyota Motor Engineering & Manufacturing North America, Inc., Plano, TX (US); Toyota Jidosha Kabushiki Kaisha, Aichi-ken (JP)

(21) Appl. No.: 17/944,538

(22) Filed: Sep. 14, 2022

(51) Int. Cl. B23G 5/06; B25B 23/00; B25F 3/00

(52) U.S. Cl. CPC B23G 5/06; B25B 23/0035; B25F 3/00; B25B 21/02

(57) ABSTRACT

A tool shank holder includes a body comprising a shank-receiving end and a bit-receiving end. The shank-receiving end is configured to operably receive a shank of a tool and the bit-receiving end is configured to operably receive a driver bit. A connector is provided at the shank-receiving end that is configured to directly connect the shank-receiving end to the shank of the tool.

### TECHNICAL FIELD

The present specification generally relates to tool shank holders and, more specifically, to tool shank holders that provide quick connections between impact drivers and tools.

### BACKGROUND

Taps are tools that are used to create screw threads in holes. The taps typically include a tapping head that includes cutting threads and a connecting shaft (i.e., a shank) that connects to a driving tool. While some driving tools may be manually operated to tap an opening, it may be desirable to use a power tool, such as an impact driver. However, the connecting shaft of the taps may not be shaped and sized to connect to a socket of the impact driver. In order to connect the connecting shaft to the socket of an impact driver, a tap holder may be used to provide an adapter between the two tools that cannot be connected together directly. However, current tap holders are cumbersome to use and must be held in place to prevent the tap from falling out of the tap holder. Holding the tap can be awkward, especially when wearing gloves that can get tangled in the assembly.

What is needed are tool shank holders that provide quick and secure attachments between tools, such as taps, and impact drivers.

### SUMMARY

In accordance with one embodiment, a tool shank holder includes a body comprising a shank-receiving end and a bit-receiving end. The shank-receiving end is configured to operably receive a shank of a tool and the bit-receiving end is configured to operably receive a driver bit. A connector is provided at the shank-receiving end that is configured to directly connect the shank-receiving end to the shank of the tool.

In accordance with another embodiment, an impact driver assembly includes an impact driver including a chuck configured to operably receive a drive bit. A drive bit is operably received within the chuck. A tool shank holder includes a body comprising a shank-receiving end and a bit-receiving end. The shank-receiving end is configured to operably receive a shank of a tap and the bit-receiving end is configured to operably receive a driver bit. A connector is provided at the shank-receiving end that is configured to directly connect the shank-receiving end to the shank of the tap. A tap includes a tapping head and a shank received within the shank-receiving end. The connector directly connects the shank-receiving end to the shank of the tap.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following description of the illustrative embodiments can be understood when read in conjunction with the following drawings, where like structure is indicated with like reference numerals and in which:

FIG. 1 depicts an impact driver assembly including a tool shank holder, according to one or more embodiments shown and described herein;

FIG. 2 depicts the tool shank holder of FIG. 1 with connected tap, according to one or more embodiments shown and described herein;

FIG. 3 depicts the tool shank holder along line 3-3 of FIG. 2, according to one or more embodiments shown and described herein; and

FIG. 4 depicts another embodiment of a tool shank holder, according to one or more embodiments shown and described herein.

### DETAILED DESCRIPTION

Tool shank holders described herein are adapters that provide a connection between mismatched tools, such as a tap and a hex drive bit of a handheld impact driver. The tool shank holders include a shank-receiving end and a bit-receiving end. The shank-receiving end is configured to operably receive a shank of a tool, such as a tap, inserted into the shank-receiving end. The bit receiving end is configured to operably receive a drive bit. A connector is provided at the shank-receiving end that connects the shank-receiving end directly to the shank of the tool and another connector is provided that connects the bit-receiving end directly to a driver bit.

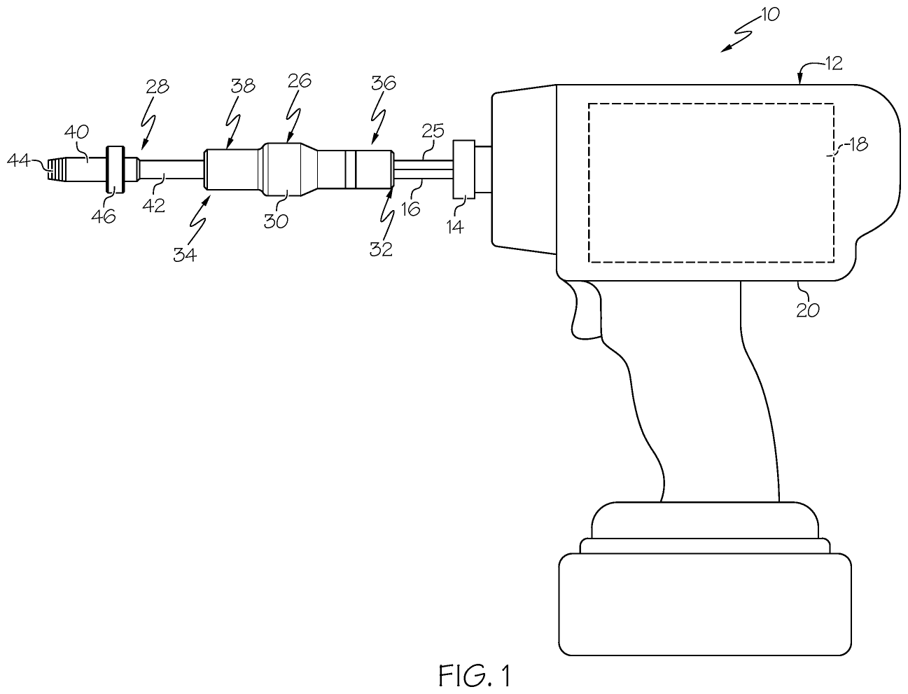

Referring to FIG. 1, an impact driver assembly 10 includes an impact driver 12 that includes a chuck 14 for receiving a drive bit 16. The term “impact driver” refers to a power tool, such as a drill, that drives a variety of bits, such as taps using the chuck 14 and a motor 18 located in a housing 20 of the impact driver 12. The drive bit 16 is inserted within the chuck 14. The drive bit 16 may be, for example, a screw bit that includes a hexagonal shank 25. The chuck 24 may include a quick-release hexagonal bore that is sized and configured to operably receive and interlock with the shank 25.

A tool shank holder 26 connects the drive bit 16 to a tool, in this case a tap 28. The tool shank holder 26 includes a body 30 including a bit-receiving end 32 and a shank-receiving end 34. The bit-receiving end 32 may be provided by a flip socket portion 36 that may be part of the body 30 and the shank receiving end 34 may be provided by a tool holder portion 38 that may also be part of the body 30. In some embodiments, such as the one shown, the body 30 including the flip socket portion 36 and the tool holder portion 38 may be formed as a single, monolithic piece of material, such as by casting. In other embodiments, the flip socket portion 36 and the tool holder portion 38 may be formed separately and then permanently connected together, such as by welding. By “permanently connected together” it is meant that the flip socket portion and the tap holder portion cannot be separated without breaking a bond between the two.

The tap 28 includes a tapping head 40 that is connected to a shank 42. The tapping head 40 may include cutting threads 44 that are configured to form a thread pattern in an opening during a tapping operation. The shank 42 may include a cross-sectional shape and/or size that is different from the shank 25 (e.g., circular) of the drive bit 16. For this reason, the shank 42 of the tap 28 may not operably mate with the chuck 24 and the tool shank holder 26 is used to transfer torque from the drive bit 16 to the tap 28 rather than connecting the tap 28 directly to the chuck 24. A depth stop 46 is connected to the tapping head 40. The depth stop 46 is provided to stop the tapping head 40 at a preselected depth into a material during the tapping operation.

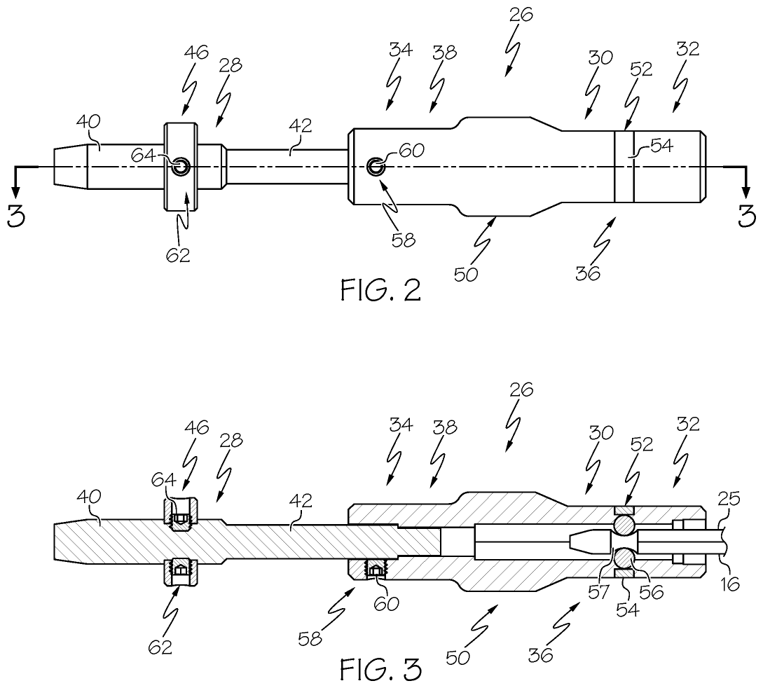

Referring now to FIGS. 2 and 3, the tool shank holder 26 and tap 28 assembly is shown and includes the body 30 including the bit-receiving end 32 and the shank-receiving end 34 that are formed by the flip socket portion 36 and the tool holder portion 38, respectively. Located between the flip socket portion 36 and the tool holder portion 38 may be an enlarged holder portion 50 having a width that is greater than widths of the flip socket portion 36 and the tool holder portion 38. The enlarged holder portion 50 can provide a handle structure to facilitate manual grasping and holding of the tool shank holder 26.

A first connector 52 is located at the bit-receiving end 32. The first connector 52 may be, for example, a ball and detent connector that includes a spring band 54 that provides a radial biasing force against a ball 56 that is received within a notch 57 of the drive bit 16. In this regard, the first connector 52 may directly connect the flip socket portion 36 and the drive bit 16. By “directly connect” in this context, it is meant that there is no intermediate structure between the first connector 52 and the drive bit 16 to connect or mate the first connector 52 to the drive bit 16 in an operable fashion.

A second connector 58 is located at the shank-receiving end 34. The second connector 58 may be, for example, a set screw connector that includes a set screw 60 that engages against the shank 42 of the tap 28. In this regard, the second connector 58 may directly connect the tool holder portion 38 and the tap 28. By “directly connect” in this context, it is meant that there is no intermediate structure between the second connector 58 and the tap 28 to connect or mate the second connector 58 to the tap 28 in an operable fashion.

A third connector 62 is located at the depth stop 46. The third connector 62 may be, for example, another set screw connector that includes a set screw 64 that engages against the tapping head 40 of the tap 28. In this regard the third connector 62 may directly connect the depth stop 46 and the tap 28. By “directly connect” in this context, it is meant that there is no intermediate structure between the third connector 62 and the tap 28 to connect the third connector to the tap 28 in an operable fashion.

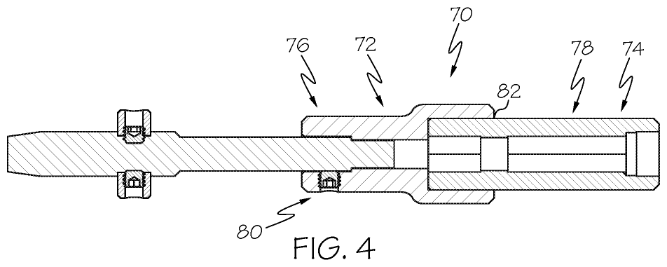

Referring to FIG. 4, another embodiment of a tool shank holder 70 is illustrated that includes many of the features described above including a body 72 including a bit-receiving end 74 and a shank-receiving end 76. The bit-receiving end 74 may be provided by a flip socket portion 78 and the shank-receiving end 76 may be provided by a tool holder portion 80. In this embodiment, the flip socket portion 78 may be formed separately from the tool holder portion 80. The flip socket portion 78 and the tool holder portion 80 may be permanently connected together by, for example, welding at seam 82.

The above-described tool shank holders allows for one-handed operation of the impact driver assembly without a need for manually holding the tap to stabilize the tap during a tapping operation. The tools shank holders can provide a secure, accurate method for attaching taps to the impact drivers that maintains concentricity the tap while rotating. The tap can be equipped with an adjustable depth stop to provide operators with visual reference when to stop a tapping operation and reverse the impact driver.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A tool shank holder for connecting a tool to a chuck of an impact driver, the tool shank holder comprising:
a body comprising a shank-receiving end and a bit-receiving end, the shank-receiving end is configured to operably receive a shank of a tool and the bit-receiving end is configured to operably receive a driver bit; and
a connector is provided at the shank-receiving end that is configured to directly connect the shank-receiving end to the shank of the tool.

2. The tool shank holder of claim 1 further comprising a tool comprising a shank received within the shank-receiving end, the connector directly connecting the shank-receiving end to the shank of the tool.

3. The tool shank holder of claim 2, wherein the tool is a tap comprising the shank and a tapping head comprising cutting threads that are configured to form a thread pattern in an opening during a tapping operation.

4. The tool shank holder of claim 1 further comprising another connector that is configured to directly connect the bit-receiving end to a driver bit.

5. The tool shank holder of claim 1, wherein the body comprises a flip socket portion comprising the bit-receiving end and a tool holder portion comprising the shank-receiving end.

6. The tool shank holder of claim 5, wherein the flip socket portion and the tool holder portion are formed as a single, monolithic piece of material.

7. The tool shank holder of claim 5, wherein the flip socket portion and the tool holder portion are formed separately and permanently connected together.

8. An impact driver assembly comprising:
an impact driver comprising a chuck configured to operably receive a drive bit;
a drive bit operably received within the chuck;
a tool shank holder comprising:
a body comprising a shank-receiving end and a bit-receiving end, the shank-receiving end is configured to operably receive a shank of a tap and the bit-receiving end is configured to operably receive a driver bit; and
a connector is provided at the shank-receiving end that is configured to directly connect the shank-receiving end to the shank of the tap; and
a tap comprising a tapping head and a shank received within the shank-receiving end, the connector directly connecting the shank-receiving end to the shank of the tap.

9. The impact driver assembly of claim 8, wherein the tool shank holder further comprises another connector that is configured to directly connect the bit-receiving end to a driver bit.

10. The impact driver assembly of claim 9 further comprising a driver bit received within the bit-receiving end, the another connector directly connecting the bit-receiving end to the driver bit.

11. The impact driver assembly of claim 8, wherein the body comprises a flip socket portion comprising the bit-receiving end and a tool holder portion comprising the shank-receiving end.

12. The impact driver assembly of claim 11, wherein the flip socket portion and the tool holder portion are formed as a single, monolithic piece of material.

13. The impact driver assembly of claim 11, wherein the flip socket portion and the tool holder portion are formed separately and permanently connected together.

14. The impact driver assembly of claim 8 further comprising a depth stop around the tapping head.

15. The impact driver assembly of claim 14 further comprising another connector directly connecting the depth stop to the tapping head.

16. The impact driver assembly of claim 8, wherein the connector comprises a set screw.
